(19) United States
(12) Patent Application Publication
(10) Pub. No.: US 2013/0268428 A1
(43) Pub. Date: Oct. 10, 2013

(54) Universal economy enhancement system

(71) Applicant: James Edward Lister Broadfoot, Toronto (CA)

(72) Inventor: James Edward Lister Broadfoot, Toronto (CA)

(21) Appl. No.: 13/815,523

(22) Filed: Mar. 9, 2013

Related U.S. Application Data
(60) Provisional application No. 61/685,044, filed on Mar. 12, 2012.

(51) Int. Cl. G06Q 50/18

(52) U.S. Cl. CPC G06Q 50/184; G06Q 40/025
USPC 705/38; 705/310

(57) ABSTRACT

The ‘Universal Economy Enhancement System’ is a business method or process that can be established and used by a single country or a group of countries to significantly improve the economy of the user country or user countries principally by significantly reducing unemployment and funding worthy projects. This is accomplished by having a new national or international institution or the like collect new business ideas or ideas for new businesses from Inventors. These new business ‘inventions’ may or may not be patentable. The UEES institution is given the right by UEES nations to determine whether the Inventor's invention is ‘new’. If it is the UEES register the new invention and the UEES receives a permanent intellectual property ownership right from UEES using countries. The ‘inventions’ are made available for use in UEES-using countries. The Inventor is compensated by the UEES based on the economic impact of his/her/its invention.

### BACKGROUND OF THE INVENTION

The world needs invention and innovation. A few of the many reasons why this statement is correct follow in paragraphs [0007] to [0015] below.

Improve Life. Generally each generation tries to maintain and improve life conditions for their children, the next generation. Inventions provide a significant amount of the desired improvement.

Create Employment. Until a new social system is in place where ‘work’ is not generally required to earn a living, the world needs invention. Globalization, automation and mechanization are reducing both highly skilled and lower skilled labor needs in many industries and countries. Professionals such as accountants, lawyers, engineers, politicians and doctors are subject to the automation of many of the functions that were previously thought of as part of their work duties. New products to manufacture or services to render will help to absorb those persons made redundant by globalization, automation, mechanization and other reasons.

Training. In a rapidly changing work environment many students and adults want to know for what type of work they should train so that they will have satisfying and rewarding careers and employment. When trends can be perceived in the training required to actualize new inventions, training can be given in areas that will provide employment.

Payment of Social Security. Many people are familiar with the declining ratio trend of social security covered workers to beneficiaries. The U.S. social security website www.ssa.gov supplies the following historical data. In 1940 there were 35,390,000 covered workers to 222,000 beneficiaries; a ratio of 159.4 to 1.

In 1955 there were 65,200,000 to 7,563,000 for a ratio of 8.6 to 1. Dramatically in 2010 there were 156,725,000 to 53,398,000 for a ratio of 2.9 to 1. It is important to keep this ratio as high as possible so that the country is able to afford to pay beneficiaries social security. The UEES should maximize employment in countries that use it.

Increase Private Sector to Public Sector Ratio. A trend that the UEES should help to ameliorate is the declining ratio of private sector workers to public sector workers. The private sector generally pays for the public sector. By putting more private sector employees into the workforce the ratio between private sector employees and public sector employees is increased and this generally indicates a healthier economy which can afford a larger public sector.

Fulfill A Human Need. New inventions may fulfill a human need for change. The evolution of the computer, the cell phone, and the television (from a black and white image, to color and soon 3D) has been eagerly anticipated by people around the world. Desired new items are acquired by people everywhere as soon as they become affordable to them.

Advancement and Power. Which country will probably be the more advanced and powerful? The country with access to a lot of innovation and invention or the country without access to innovation and invention. The answer is apparent.

Environmental maintenance and improvements. The world may have reached a tipping point with regard to its being a habitable place for humans and other living things. New inventions may be required just to keep the global environment within life support limits. These inventions may be very necessary and very big business. See paragraph [0028].

‘Food Supply. As the population of the world grows and climate change occurs new strategies and inventions such as may be found in the field of genetic engineering may be required to ensure global food supply.

There are now a number of impediments to commercialization of innovation and inventions. Some are noted in paragraphs [0017] to [0021].

The Inventor of a new business idea is not necessarily motivated to transfer this invention information to anyone or to utilize the idea himself/herself. Inventors may not be able to commit enough time to develop the invention. Some Inventors may not have the experience necessary to develop their invention or they may not desire to pursue the commercialization of the idea. In fact, they may forget about it altogether although it could have been very commercially significant.

The business idea may require more financial resources or other resources like time than the Inventor can make available.

The new business idea invention may not be patentable and, when it is known about, competition may rapidly overwhelm any business that the Inventor could establish and he/she may reap no or little reward. Since most people work for monetary and psychological reward it takes a very special individual to be both the Inventor and implementer of an invention. The UEES allows the idea-type person be successful. He or she may then implement the invention or leave that function to others.

If the business idea is patentable and a national patent or international patents are applied for, the patent applicant must be prepared to finance the acquiring of the appropriate patents then defend them against infringers of the patent holder's rights. These costs can run into many millions of U.S. dollars and may take many years to reach a final verdict or resolution. In some cases the legal cost may only be affordable by large companies. The UEES institution becomes the owner of the registered UEES invention so there is no need for the Inventor to concern himself with legal challenges. The UEES legal department will deal with legal problems. Consider the problems that the Inventor of the intermittent car windshield wiper system, Robert Kearns, encountered. It is perhaps obvious that the UEES is somewhat similar in some respects to patent systems around the world. Table 2 has been included in the application that shows some of the many differences between the UEES and patent systems.

There may be over a one year wait from the time the patent is applied for until a patent is granted. Once the UEES has been fully implemented the time to process a submitted invention should be significantly less. New business ideas. should get into the market as soon as possible to produce employment and other benefits for UEES using countries and the world. One of the reasons this will be the case is because it is in the financial interest of the UEES institution to expedite the processing of Inventor submissions as the UEES is supported by the approved and implemented UEES registered inventions.

What is the global economic situation? Does it require new approaches to solve such economic problems as unemployment, underemployment or keeping the world in a habitable condition? Paragraphs [0023] to [0028] below mention a few current economic problems around the world that suggest changes like implementing the UEES would be beneficial for the UEES country economies.

The United States Bureau of Labor Statistics published the following statistics for January 2013:

The U.S. official unemployment rate or U3 is 7.9%.
The U.S. official unemployment rate or U6 is 14.4%.
The U.S. unemployment rate for blacks is 13.9%.
The U.S. unemployment rate for Hispanics is 9.7%.

In the Eurozone region the unemployment rate in December 2012 is reported to be 11.7%. The current rate is a record high. In Greece the unemployment rate was 26.8% and in Spain the unemployment rate was 26.1%. There are 18.7 million people unemployed in the 17 countries that comprise the Eurozone. In the Eurozone there are 1.8 million more people unemployed now than there were at the same month of the previous year. Source—Eurostat as reported by Qatar News Agency.

Youth unemployment is a large problem in many places. This is exemplified in a BBC report that indicates that the Spanish rate of unemployment for youth between 16 and 24 for the last quarter of 2012 was 55.13%. In Italy the same report notes that unemployment among young people for the same period was approximately 37%.

Recent Google alerts for ‘economy’ include headlines such as:

The Economy Looking better—Chicago Tribune
Spanish economy shows glimmers of hope but prime minister gets no love—Christian Science Monitor economy—Walter Russel Mead
U.K. economy contracted 0.3 per cent in the 4^{th} quarter—finance/yahoo.com/---/uk-economy-contracted-0-3 pct-fourth
U.S economy gets lift from housing other tailwinds—ABC news
Timothy Geithner saved Wall St. not the economy—Huffington Post
Triple digits oil in sight as global economy heals—CNBC.com
The ideology of the expendable employee—NPR
Britain's economy is a disaster and nobody is entirely sure why.—The Atlantic
Annual gathering of world's elite dominated by fragile state of world's economy.—Fox news
World economic forum ends with stark warning over global economy.—Business Insider
The rise of the permanent temp economy.—New York Times (blog)
China economy to underpin global demand in 2013—CIC
Europeans fill jobs void in Chile's thriving economy—European Daily—marctosenburger
Geithner sees the U.S. economy as strengthening gradually—U.S. News and World Report

The economic data shown and many of the article's titles confirm that there are significant economic problems in many, if not most countries, or in societal groups within countries around the world. The main economic problem appears to be lack of employment. The UEES addresses this key problem and others.

The United Nations Environment Program published a document in June 2012 entitled GEO5. It is available for review on the internet. The report cautions that if humanity does not urgently change its ways, several critical thresholds may be exceeded beyond which abrupt and generally irreversible changes to the life-support functions of the planet could occur. The United Nations Environment Program warned the earth's environmental systems “are being pushed towards their biophysical limits,” beyond which loom sudden, irreversible and potentially catastrophic changes, “If current trends continue, if current patterns of production and consumption of natural resources prevail and cannot be reversed and ‘decoupled’, then governments will preside over unprecedented levels of damage and degradation,” said UN Under-Secretary General and UNEP Executive Director Achim Steiner.

The Universal Economy Enhancement System may be used to raise very large amounts of funds. These funds could and should be used to address the global concerns such as environmental degradation, food shortages, health issues and other problems of humanity. See paragraph [0032] below.

### The ‘Universal Economy Enhancement System’

This application claims the benefit of U.S. Provisional Application No. U.S. 61/685,044, filed Mar. 12, 2012 (03/12/2012) which is incorporated herein by reference. The provisional application includes the most important and crucial ‘prophetic’ example that was submitted several times in both paper hard copy and CD disc formats.

### Glossary and Grammar

IDEA BANK—The division of the UEES institution that receives the idea from the inventor is also called the ‘Idea Bank’.

INVENTION—An ‘invention’ is a term used for any new idea for a business or new business idea. The invention may be for a new product that could be manufactured, service that could be rendered or a new design of an existing product that could be manufactured or the like. The idea may be patentable or not patentable. ‘New business ideas’ or ‘ideas for new businesses’ can be partially defined by what they are not. An invention may not be a UEES business if it is or has been a business idea for goods and services that are already implemented business ideas for goods, services or designs prior to the date the UEES comes into being. It cannot be a patented idea for goods, services or designs available prior to the date the UEES comes into being with the exception of patents assigned to the UEES or ideas for goods, services or designs already used. If the business idea has been made generally known to the public subsequent to the date the UEES comes into being and the ideas were not previously submitted by the Inventor(s) to the UEES institution for registration they cannot be registered as UEES inventions. U.S. Patent Law defines ‘invention’ as a new, useful process, machine, improvement, etc., that did not exist previously and that is recognized as the product of some unique intuition or genius, as distinguished from ordinary mechanical skill or craftsmanship. The UEES definition of ‘invention’ is for new business ideas. That includes the U.S. patent definition but expands on it as noted above.

INVENTOR—In this application an Inventor is a person, company organization or the like that submits a new business idea or a new idea for a business to the UEES institution. The UEES recognizes the Inventor of an idea to be the first person to send the new business idea to the UEES. This is known as ‘first to file’. If the Inventor wishes to be the recognized Inventor of a UEES business idea it will be necessary and advisable to send the invention to the UEES institution for review.

JELB—is the patent applicant ‘James Edward Lister Broadfoot’.

UEES—is the acronym for the ‘Universal Economy Enhancement System’.

HE—When ‘he’ is used it can be replaced or used interchangeably with the pronoun ‘she’ or ‘it’ as appropriate unless referring to the deity.

HIS—When the adjective ‘his’ is used it can be replaced or used interchangeably with the adjective ‘her’ or ‘its’ as appropriate unless referring to the deity.

HIMSELF—When ‘himself’ is used it can be replaced or used interchangeably with ‘herself’ or ‘itself’ as appropriate unless referring to the deity.

LICENSING FEE—When ‘Licensing fee’ is used it may also mean ‘fee’, ‘charge’, ‘royalty’, ‘commission’ or ‘payment’.

SALARY—When the word ‘salary’ is used it may also mean ‘wage’ or ‘compensation’.

COUNTRY—‘Country’ may also mean ‘nation’ or ‘state’.

### FIELD OF THE INVENTION

The present invention is directed generally to the sourcing and gathering of new business ideas or new ideas for a business (inventions), the reward of new business idea Inventors, the development and commercialization of new business idea inventions, the maximization of the use of labor available in productive private sector work in the workforces of UEES using countries and the acquiring of large amounts of capital to be used for the benefit of mankind and nature in projects such as keeping the world in a habitable state for humans and other living things, reducing health and hunger problems around the world and other positive projects as may be important and appropriate in their time.

### LIST OF DIAGRAM AND TABLES

Diagram 1—The Universal Economy Enhancement System. A diagrammatic depiction.

Table 1—Annual Payment Made to Inventor based on Net Sales.

Table 2—General Comparison of Patent Systems and the UEES

Table 3—Macro Example 1—Total Amount paid by national Government

Table 4—Macro Example 1—Illustration of Loan Repayment & Cost of Program. See paragraph [0122] for an example description.

Table 5—Macro Example 2 Total Amount paid by the National Government to support UEES wage/salary loans. Example in paragraph [0123].

Table 6—Macro Example 2—Illustration of Loan Repayment & Cost of Program. Example in paragraph [0123].

Table 7—Cost to provide UEES salary to different numbers of recipients and different annual amounts. General information.

Table 8—Illustration of Government Loan and its Repayment. Example of information in paragraphs [0070] and [0101].

Diagram 1—The Universal Economy Enhancement System. This diagram shows a depiction of the Universal Economy Enhancement System (UEES). It is described in paragraphs [0055] to [0062]. At the top of the diagram the Inventor is shown. He has an invention and he sends it to the UEES institution. The diagram shows by arrows the invention being transmitted to the UEES institution. The invention could be transmitted to the UEES institution in almost any manner. It could be sent by mail, email, by recorded telephone call, video, CD, tape or the like.

The Universal Economy Enhancement System or UEES organization or institution receives the invention from the Inventor. Staff at the UEES institution record the receipt of the invention and forward an acknowledgement of the invention's receipt to the Inventor. The invention is then reviewed by UEES staff. The UEES staff will translate the material received into a working language of the UEES's organization. The staff will also put the invention received into its most marketable form. After this has been done other staff at the UEES institution will judge whether the new invention submitted is in fact a new registerable invention.

If it is decided that the invention sent to the UEES is not registerable, the

Inventor is informed of the UEES institution's decision. The Inventor will also be informed as to why that decision was made.

The diagram shows the symbol ‘UEES registered invention’. This is an invention that has been registered by the UEES institution as a new business idea invention. The registered UEES's invention is now made available to people, companies and the like in UEES countries to use in exchange for a licensing fee. In the diagram the people, companies and the like are depicted by symbols containing the words individual proprietorships, companies and institutions, organizations or the like.

The diagram then depicts the licensing fees being transmitted to the UEES Financial division or UEES Bank.

The UEES bank processes the licensing fees received. The licensing fees are associated with a UEES invention registration number or numbers. The portion of the licensing fee that is due to an Inventor associated with an invention registration number is sent to the Inventor or held in an account in his name. This is depicted in the diagram by the arrows going to the Inventor.

The UEES bank or financial division also dispenses funds to reimburse the operating costs of the UEES institution. This is depicted by arrows on the right side of the diagram that go to the UEES organization symbol.

There is also an arrow to ‘Payments made to benefit humanity/nature’. This depicts payments to organizations or the like providing and/or implementing solutions in areas of concern like the environment, health or food stability.

Table 1—Annual Payment made to Inventor probably based on net sales. This chart illustrates the annual commission that the Inventor will receive based on the reported cumulative net sales of his invention. Column A is multiplied by column B to get the annual amount paid.

Table 2 —General Comparison of Patent Systems and the UEES

Table 3—Macro Example 1—Total Amount paid by national Government

Table 4—Macro Example 1—Illustration of Loan Repayment & Cost of Program

Table 5—Macro Example 2—Total Amount paid by national Government

Table 6—Macro Example 2—Illustration of Loan Repayment & Cost of Program

Table 7 —Cost to provide UEES salary/wage to different numbers of recipients and different annual amounts. This chart shows the total cost to the national government to pay a specified number of UEES company workers a specified national UEES. wage/salary loan.

Table 8—Illustration of Government Loan and its Repayment. See also paragraph [0101]. Table 8 shows that there are five staff associated with this UEES invention project. Column A of the chart shows that all five staff received a $20,000 loan from the government this year. Column B of the chart shows the negotiated salary/wage of each UEES employee. When each employee joins the company he negotiates what his salary/wage will be with the company. When and if the company working on a UEES invention can make a salary/wage distribution it will be done in the ratio of the amount the individual staff is owed to the total amount owed to all staff. This is illustrated in column C. In the FIG. 6 illustration a distribution of $180,000 is assumed to have been made. The amounts distributed to each employee are shown in column D. The company or the staffs, when they receive the distribution, are legally bound to repay any government loan they receive before they can retain or pay income taxes with any remainder after deducting the loan repayment from the distribution received. This is illustrated in columns D, E and F. Column G shows the salary/wage that is still due to each staff assuming they have all worked for one year and the distribution was made at the end of the year.

### DETAILED DESCRIPTION OF THE INVENTION

See Diagram 1. The first purpose of the Universal Economy Enhancement

System is to establish a process/method/system that will minimize the loss of viable new business ideas or new ideas for businesses that Inventors may have. This is achieved by having a very inventor-friendly invention acquisition system. Some of the characteristics of such a system should be our listed in paragraph's [0072] to [0083]

There should be no cost to the Inventor other than perhaps the cost of a stamp or the cost to send an email or the like.

In order to encourage all Inventors to submit their ideas the Inventor of the new business idea should receive generous compensation based on the commercial success of his/her/its/their invention.

The Inventor should never have to concern himself with legal matters like lawsuits.

The Inventor should only have to deal with a single party. That party should be the party to which he/she/they/it sends their invention.

The party to which the Inventor sends his invention should have an interest in the success of the inventor's invention.

The Inventor should be able to receive protection from the party or the country to which he sends his invention against threats.

The system and Inventors should receive the full legislated support of the governments of nations using the UEES.

The Inventor should be able to receive funds due to him in a timely manner.

The Inventor should be able to verify that he is receiving all the royalties that he is due.

The party to whom the invention is sent must provide detailed records of how the remuneration paid to the Inventor was calculated.

The party to whom the Inventor sends the invention must be absolutely honest and open regarding the invention and its operating methods. And the like.

A method to accomplish the goals and objectives the UEES is to establish a new national or international ‘UEES’ institution. See Diagram 1. Some of the functions of the UEES institution are listed in paragraphs [0084] to [0089]

Receive inventions from Inventors. The inventions should be receivable by the UEES institution in any reasonable format; for instance, mail, email, recorded phone call or recorded Skype etc. There should be no formal structure necessary for the invention to be drawn up in. The invention should also be able to be transmitted and received in any national language, not just the language of UEES using countries. This recognizes the fact that good inventions could come from an Inventor in any country. An Inventor should be able to have an invention idea, write it up immediately and mail it in or otherwise communicate it to the UEES institution. Staff at the UEES should put the communicated invention in a format that could be used to determine whether the submitted invention could be registered by the UEES institution as a new idea for a business or a new business idea.

Acknowledgement. It will then be the work of the institution's staff to immediately acknowledge the receipt of the invention with a time and date-stamped copy or the like of the invention received.

Good Form. The institution staff will convert the invention document into a working language and put the invention specifications in good form. If the employees feel it necessary they should confirm with the Inventor that their interpretation of the Inventor's submission is what the Inventor intended to convey.

Analysis. When this has been done the invention will be analyzed by

UEES institution staff to determine whether the invention idea submitted is actually a new business idea or a new idea for a business. If it is not a new idea for a business the Inventor will be so informed with as much information about why this evaluation was made as possible.

Registration. If the Inventor's idea is ruled to be a new invention by staff at the UEES institution then UEES staff register it as such and the Inventor is notified of this favorable ruling. The invention is given a UEES invention registration number. This number will be used by both the UEES institution and the Inventor to track information about the invention.

Marketing. The next step in the process is for the UEES institution to market UEES inventions. (It is called a UEES invention because by transmitting the invention to the UEES institution the Inventor has surrendered ownership of the invention to the UEES institution for the reward of a stipulated royalty and other benefits. Individuals, companies (including co-operatives, proprietorships, partnerships and corporations) whether for profit or not-for-profit, other institutions and the like in UEES using countries review the UEES's inventions. If entities in UEES countries wish they can use any UEES invention; however, they are obligated by legislated national and international law to pay the licensing fee at least annually for the use of the invention. At this time the method the UEES institution would probably use most to make the inventions available to the entities in UEES countries would be a searchable database on the internet. UEES institution staff would design the searchable database to be very user-friendly. In addition to general information about the invention, staff at the UEES institution might include searchable suggestions for which parties or entities would most likely benefit from using the invention. Categories of information might include information about which inventions have had the greatest economic impact, or what professional groups could be interested in the invention or what type of economic zone might find the invention attractive. An example of this might be that there is a high unskilled labor component to producing the invention so an economic zone with abundant lower-cost unskilled labor would appear to be a competitive place to produce the invention. If appropriate other types of media could be used to distribute information about the invention. The media could include but are not limited to printed media such as catalogues, magazines, newspapers, brochures and the like. Media like television and radio could also be used to create a demand for or interest in producing or offering new UEES product and service inventions.

At this point in the explanation of the UEES the Inventor has sent the invention to the UEES institution, the UEES institution has received the invention, acknowledged the reception of the invention to the Inventor, assessed the invention as to whether it is indeed a new business idea invention, informed the Inventor as to the results of the UEES institution staff's appraisal and, if the invention is determined by UEES staff to be a new invention, the UEES staff have commenced by various means to market the invention.

How will the inventor be compensated? How will the operating costs of the UEES institution be paid and how will large amounts of money be raised for the purposes stated above in paragraph [0045] elsewhere.

See Table 1—Annual Payment Made to Inventor based on Net Sales. It is important that the Inventor be very well compensated for sending his idea to the UEES institution if the idea is new invention. Not only does that make the Inventor happy but it will inspire all people to submit their ideas to the UEES institution to the benefit of UEES using countries and the world at large. Without the Inventor's initial invention the CEO and all the staff of a UEES invention inspired business would not have employment. It might be a bit of an exaggeration to say that there would be no telephone communications companies without Mr. A. G. Bell or there would be no electrical system without Mr. T. Edison but the applicant thinks the point is clear enough if not the example. How can the Inventor be compensated in proportion to the economic value of his invention? The patent applicant JELB believes an uncomplicated method from the prospective of all parties would be to pay a licensing fee for the use of the UEES invention based on the net sales of the product invention that is manufactured or the service invention that is rendered. Net sales are normally defined as gross sales less sales returns and allowances and discounts. The Inventor should be paid 2% of net sales no matter how high the sales rise. See Table 1. As noted, the most important outcome of the UEES would be to instill in the world population the importance of being aware of what might possibly be a new business idea invention and the importance of submitting any potential invention to the UEES.

When thousands or millions of dollars or another currency can be earned annually by Inventors this will certainly inspire emulation by the global population. Just how many new business idea inventions are there available for development? Perhaps there are a lot and they will come along regularly with anticipated scientific advancement. However, perhaps soon or in the more distant future there will not be so many ideas, not enough to absorb the workforce available. This would make each new business idea invention very valuable. It would be disastrous to have a compensation regime that did not inspire full global participation by Inventors. How long should the licensing fee be paid from the UEES institution to the Inventor? The applicant believes that owing to the fact that it will be impossible to tell how quickly the invention will be used, the Inventor should be paid the royalty for life or 25 years, whichever is longest. e.g. If an Inventor dies 15 years after his invention was registered his estate would continue to receive the Inventor licensing fee for another (25-15=) 10 years. If the Inventor discovers the invention at age 25 and lives to age 85 then the Inventor will receive the licensing fee for (85-25=) 60 years.

What will be the operating costs of the UEES institution? This institution will have to be a very substantial operation. It will require interpreters, invention reviewers in many fields, researchers, industrial specifications writers, financial personnel, legal staff, maintenance, engineering staff, secretarial and management staff in many areas and probably many other types of personnel. Consider that the US Patent office is reported to have about 6,900 employees. If the volume of invention applications is similar to or even higher than the US Patent Office then this UEES institution would be a major undertaking. Eyeballing the potential cost of the UEES institution the applicant believes that a further 3% licensing fee must be added to the 2% licensing fee paid to the Inventor to cover the costs of the UEES institution. For a comparison of UEES features to patent system features see Table 2—General Comparison of Patent Systems and the UEES.

Licensing fee allocated to benefit humankind and nature. See paragraph [0095].

All or almost all businesses have a direct effect on people and the environment. Energy must be expended and pollution is generated when employees travel to and from work or to clients in cars, trains, airplanes or other public transportation. Computers, lights, heavy industrial equipment all require power to operate. Work stresses and injuries cause health problems that often require expensive medical care. It has been widely reported that countries around the world are not putting enough capital into programs that will keep the world in a habitable condition. See paragraphs [0028] for more information about this problem. The patent applicant believes that a further 5% license fee be added to the 2% Inventor's compensation license fee and the 3% UEES Institution operating fee. This 5% would be used for the purpose of covering any additional operating costs of the UEES as the UEES institution's costs may exceed the 3% projected costs, particularly in the early years of the UEES institution's operation. Amounts of capital raised from licensing fees and not used for the operation of the UEES institution or for Inventor remuneration could and should be used to ameliorate the damages caused by business activity or for other important projects. It is anticipated that in the future the amounts raised could be extremely large and could provide considerable assistance maintaining the earth in a habitable condition and other very worthwhile projects. The executive of the UEES should designate who the recipients of this spending will be as they will have an international orientation and do not have the contentious competition for funds that national governments have.

Reduction of unemployment. Is it possible that there need not be unemployment in a country for physically and mentally ‘fit’ persons? This topic will be discussed in paragraph [0099] to [0101]. Before considering this situation, a review of what having more new business inventions will mean to the workforce in a country will be undertaken.

An unknown proportion of the new UEES inventions will be inventions that people either want to have or need to have. Consider the situation were an Inventor has a new idea for a computer application (program) or ‘app’. He does not know how to program computer code so he sends his invention idea to the UEES institution. The UEES institution staff recognizes the benefit of the concept for this new app, registers the invention as a UEES invention and distributes the concept to UEES countries. One or more individuals or companies in the UEES countries view the concept and decide to develop and market the app. This is done and the app is found to be very popular. Licensing fees of 10% of the net sales of the app are remitted by the companies that used the invention to the UEES bank. The UEES bank distributes to the Inventor the Inventor portion of the licensing fee, which is 2% of the net sales of the distributing companies related to the sale of the app. It also pays the bills of the UEES organization. Any amount not required by the UEES institution may be made available to organizations or persons trying to maintain the world in a habitable condition or other worthy causes. This method of using the UEES may be the simplest. Work and therefore jobs have been created in the actualization of a UEES invention.

How can ‘full employment’ be achieved in UEES using countries? One method will be demonstrated.

First, the citizens in a UEES using nation must decide that they want ‘full employment’. The governments of the UEES using nations must then concur with the will of the people and take several general actions. The first action will be to reserve all or most UEES inventions for the use of UEES company workers. This is done so that UEES companies do not have to compete with already established private sector companies. UEES workers are people who choose to work on the development and sale of UEES inventions. They may have been unemployed persons, recent students now looking for work experience or even people that leave the workforce to work on an invention that they believe could be very profitable for them and/or it has great interest to them. The second action to be taken by governments is the establishment of a government wage/salary loan program to UEES workers. This concept is explained in paragraph [0101].

See Table 8—Illustration of Government Loan and its Repayment. When workers work on UEES invention projects they will be loaned a specific amount every week or two weeks by the government. Only one amount will be given to all workers. This loan amount should be equivalent to receiving a small salary. In the year 2013 in the United States it might be around $20,000.The amount should be enough to pay for modest living expenses. This loan amount is shown as a debt to the government in the UEES worker's national tax record. The UEES worker is employed by a UEES company to work on a UEES invention. He may work alone or with other UEES workers in a UEES company. If he works in a multi-person UEES company the UEES worker will also negotiate a normal salary with the UEES company. As the UEES company starts to earn money it will pay those business debts it must pay to continue in operation. If funds are still available after paying the business debts the company will make a wage/salary distribution to its workers. Each worker will receive a portion of the distribution in proportion to the amount of wage/salary he is owed. If there are 5 workers in a UEES company and the first is owed $40,000 the second $50,000, the third is owed 55,000, the fourth is owed $65,000 and the fifth $70,000 the total amount owed will be ($40,000+$50,000+$55,000+$65,000+$70,000)=$280,000. In any distribution UEES worker 1 will receive 40000/280000=14.287% of the distribution, worker 2 will receive 50000/280000=17.857%, worker 3 will receive 55,000/280,000 =19.643%, worker 4 will receive 65,000/280,000 =23.214% and worker 5 will receive 70,000/280,000=25% of the distribution. (14.2857%+17.8571%+19.6429%+23.2143%+25%)=100.000%. When a worker receives a wage/salary distribution from a UEES company he must first pay the government back any loan that has been given to him by the government. Assume the workers have been employed one year and they have all received a $20,000 loan from the government. If the distribution is $180,000 then worker one will receive (14.287%×$180,000)=$25,714.29, worker 2 will receive (17.867%×$180,000)=$32,142.86, worker 3 will receive (19.643%×$180,000)=$35,357.14, worker 4 will receive (23.213%×$180,000)=$41,785.71 and worker 5 will receive (25%×180,000)=$45,000. Proof−($25,714.29+$32,142.86+$35,357.14+$41,785.71+$45,000)=$180,000. In this case all of the workers can pay back the $20,000 government loan loaned to them during the year. The UEES workers will have to pay income tax on their earnings when the distributions they receive are greater than their negotiated annual wage or salary. As UEES workers will want to earn the full negotiated salary they will choose the UEES invention to work on that the UEES worker believes is most likely to succeed in paying his full negotiated salary and is the most interesting or that gives the worker the most experience or training that he wants for his career. The patent applicant suggests that the maximum ratio between the pay of the highest paid worker and the lowest paid worker in a UEES company be no more than 3 to 1. No incentive, bonus or other like payments should be allowed in UEES companies. The structure of the UEES company should be fair, transparent and uncomplicated. It is one of the goals of a UEES company to become so successful that it can change its status to a regular private sector company. After this transition the company will continue to pay the full licensing fee for the use of the UEES invention. This area is covered in greater depth in the ‘prophetic example’ submitted with the provisional patent application and the provisional patent application itself.

Where will UEES companies raise capital needed for business? The same place as private sector companies. Banks, venture capitalists, family and friends, government sources, UEES employees own pockets and the like. The raising of capital is a good test as to whether ‘outsiders’ believe that the invention chosen to be worked on could be profitable in the marketplace and the UEES company's team, assembled to actualize the invention, is deemed adequate or better.

There will be costs to the UEES using nation to operate the UEES. There are many costs to not operating the UEES. Some compelling reasons for nations to use the UEES are found in paragraphs [0104] to [0121].

The UEES should work with all known types of economic systems and should be relatively easy to implement.

Almost all workers displaced by automation, globalization etc. should be able to rapidly acquire new UEES employment.

In some countries the UEES can provide an alternative to some types of social security programs. Welfare and related services, such as mental health care services should be drastically reduced as most employable workers will have UEES employment and will not have to bear health-destroying stresses caused by unemployment or underemployment.

Working in private sector jobs will maintain and expand the job experience of UEES workers. If they switch to a job in the private or public sector they should be able to easily transition to their new employment.

Inventiveness will be encouraged among people everywhere.

UEES workers may find that they can hold positions in which they have more responsibility and in which they utilize more of their abilities and skills than they might be able to hold in a normal economy position.

Because UEES company employees will receive a salary loan from the state they will be confident that they can spend the money that they receive from the state. This continual spending by UEES employees and companies will stimulate the normal economy.

UEES employees must repay UEES salary loans they have received from the state before they can receive salary payments from a UEES company or any other. This reduces considerably. the cost of the UEES program to the state.

One of the principal goals of a UEES company is to become a non-UEES private sector business. This evolution should strengthen the economy of UEES using countries. This would normally happen at or close to the point when the UEES company can successfully pay most of its debts including wages and salaries to UEES employees. All debts to the government must be completely repaid before a UEES company can become a non-UEES private sector company.

As people will be usefully occupied in UEES work, social disturbances that may be caused by chronic long-term unemployed persons will be reduced.

UEES employees will have much the same sense of self-worth that results from contributing to society through their work as normal economy employment provides.

UEES employees and companies that can quickly adopt new ideas will frequently be working on the exciting cutting edge of technology, business, education and the like.

A UEES employee's salary credits for back pay will be passable or transferable by law in a will to beneficiaries in the same manner as ‘real’ money or investments when all liabilities, including loans and taxes due, have been paid.

In some countries, academically inclined persons will be able to pursue their academic interests more easily because, after the age of majority as they may become ‘UEES students’. This option is explored below in paragraphs [00125] and [00126].

The UEES is flexible and promotes economic stability. When a country's normal economy is weaker with high unemployment rates in a UEES country the UEES presence is more prevalent. When the normal economy in a UEES using country is strong with high employment rates in a UEES country the presence of UEES companies is diminished. In national recessions or depression citizens in UEES countries should suffer considerably less economic stress than is found in non-UEES countries.

In economics a multiplier effect occurs when people have money and put it in the bank to be loaned out again. Economists can explain how the UEES would have a simulative effect on a UEES nation's economy.

When workers wonder what they will do today and tomorrow they will have answers. Older workers and younger workers, skilled workers and unskilled workers, educated and uneducated workers will have a good opportunity to find rewarding employment.

The UEES will continually provide ‘hope’.

Macro example 1. See Table 3 and Table 4. Since no hard data is now available several western-style scenarios are considered. The first example considers that 20,000,000 (twenty million) people are paid a UEES salary wage of $20,000 per year. The total outlay of the national government would be (20,000,000 people×$20,000=) $400,000,000,000 (four hundred billion dollars). Assume the UEES has been operating for a few years. This would mean that there would be repayments of the government loans occurring on a regular basis. The expectation is that a significant portion of the loans the government makes will be repaid by workers on UEES inventions. In this example assume 80% of UEES workers will find UEES work that will pay them at least $20,000 a year or more. The $400,000,000,000 (four hundred billion dollars) of loans will be reduced by 80%. This means the repayment will be (80%×$400,000,000,000=) $320,000,000,000. The UEES salary loan program has now cost only ($400billion-$320 billion=) $80,000,000,000 (80 billion dollars). But the revenue to the UEES country's national government did not stop with the repayment of loans. Of the (80%×20,000,000=) 16,000,000 UEES workers that repaid $20,000 of their loan in the year, a percentage will also pay income tax because their earnings have been sufficient to trigger tax under national government law. Assume the 50% of the 16 million people earned an average of $50,000 and paid an average 10% income tax on the $50,000 of taxable income. This would amount to (10%×$50,000=) $5,000 average income tax for 8 million people. The tax collected would amount to ($5,000×8,000,000 people=) $40,000,000,000 (forty billion dollars). The remaining cost of the salary loan program was $80 billion and the tax revenue received was $40 billion so only ($80 billion−$40 billion=) $40 billion of the cost of the UEES program was not repaid to the government at this time under these assumptions. Put another way it has cost the government, in this example, ($40 billion÷20 million people=) $2,000 per person to keep 20 million people working and generating economic development. What would welfare have cost at $30,000 per person? Would the benefit end there? As noted in paragraphs [0104] to [0121] there would be significant other monetary, societal and spiritual benefits expected to which a dollar amount have not been assigned in this example. Examples of the benefits would be a. a considerable reduction in welfare costs both for welfare payouts and welfare administration, b. improved health due to lowered stress levels would significantly lower medical costs, c. less crime would result from people being occupied with their UEES employment. This would result in savings on security (police, jails, protection systems, etc.). There are many other benefits of the UEES that would have an actual dollar benefit to UEES using countries. The value of these benefits in a country like the USA would certainly be 10's of billions of dollars, even hundreds of billions of dollars.

Macro Example 2—See Table 5 and Table 6. Consider the scenario in which 40 million persons enter into UEES employment situations. That is twice the number of the previous example. They are each paid a $30,000 UEES annual wage/salary loan by the government. This is $10,000 more per person per year than the previous example. This would amount to a total government loan expenditure of (40,000,000 people×$30,000=) $1,200,000,000,000 (1.2 trillion dollars). Again the situation is that loans will be being repaid to the government by persons that received UEES wage/salary loans from the national government. Instead of using the 80% from the prior example make an assumption that only 40% of the UEES workers paid the government back the $30,000 annual wage/salary loan they received. That would be (40%×40,000,000 people=) 16 million people. When 16 million people pay the government back the $30,000 loan the government will receive (16 million people×$30,000 loan=) $ 480 billion. The state would require a further ($1.2 trillion−$480 billion) $720 billion to reduce the loan balance to $0. As above the nation will receive taxes from some of the UEES workers. Assume again that 50% of the UEES workers that repaid the UEES loan will also pay income taxes because they received a distribution from a UEES company that was equal to their negotiated wage for this year or prior years. Using the assumptions as in the prior example (16 million×50%=) 8 million people would pay $5,000 each to the government in income taxes for this year or prior years. (8 million people×$5,000 tax=) $40 billion. This means that ($720 billion−$40 billion=) $680 billion must still be received by government to cover the costs of the UEES loans. According to the US Department of Health and Human Services the cost per person for welfare is $30,675 per person on welfare calculated ($131.9 billion total cost divided by 4.3 million persons). The cost for welfare for 40 million persons on welfare at current rates would be (40 million×$30,675 per person=) $1,227,000,000,000.00 (1.227 trillion dollars). In this extreme example, without trying to assign a dollar value to the further benefits of operating the UEES system, the UEES would have saved the government ($1.227 trillion welfare cost for 40 million people−$680 billion cost for the UEES=) $547,000,000,000 ($547 billion). This example does not apply to the current times (February, 2013) but to a possible future employment situation which could be considerably different than the current situation.

### Uees Students

Frequently students wish to pursue a university, college or other post-secondary school education. Most educational institutions require post-secondary students to pay tuition fees. These fees may be paid by parents that have prepared to make this outlay, by student self-funding activities like part-time jobs, or the obtaining of loans, bursaries, scholarships or grants or some combination thereof. In spite of the combinations of options available there are many qualified students that cannot afford to get as much ‘higher’ education as they wish to attain.

The UEES provides another way to assist a student to obtain his academic goals. UEES students will receive a UEES salary from national governments. As a legal adult, a student in a UEES country can apply to become a UEES student. When the student starts classes they will start to receive the UEES student loan from the national government. This UEES student loan will be the same amount as the UEES salary loan. Countries may decide applications for a student UEES salary loans may be made annually. The student's academic activities might be the criteria for whether the student qualifies to obtain the UEES student salary loan. UEES students will be expected to take UEES jobs if they cannot get normal economy work. If the former UEES student becomes an employee of a UEES company he will continue to receive a UEES salary. Whether in the normal economy or UEES employment the student that received a loan must repay all UEES student loans he has received and taxes due before being entitled to his earnings. The UEES salary can continue until all UEES salary loan payments have been completely repaid to the government. Of course the loans can be stopped at any time by the receiving person. All UEES countries must consider and legislate the priority of the UEES Student salary loan program. Students that seek to avoid the prompt repayment of their UEES student salary, particularly by moving to another country must be returned for discipline to their UEES country of origin by the new UEES country of residence. If a non-UEES country does not return the student to his country of origin then the non-UEES country may become a country against which economic or other restrictions may be applied by all UEES countries. UEES governments may review the applicability of the UEES student program in their country. A plebiscite might be a method of determining whether the nation would like to establish and support a UEES student program in the UEES country.

### National Governments Role in the Uees System

In most cases national governments represent the national character and will of their people. A national government, expressing the will of its people, will decide to accept and implement the UEES or to reject it and its implementation.

Initially, membership in the association of UEES countries should be available to all countries. Member countries must agree to legislate the implementation of the UEES in a similar manner.

For those countries that do wish to implement the UEES, there are some commitments that should be made. Several of these commitments appear below in paragraphs [0129] to [0150].

UEES countries must adopt the UEES completely and commit 100% to the spirit of the UEES.

UEES countries should review paragraphs [0071] to [0082]. They should develop and provide legislation that will satisfy Inventors in regard to these points.

Countries that decide not to be part of the UEES must not use UEES inventions.

UEES countries must establish the UEES system legally in their country.

National governments will legislate the concept that new business ideas registered by the UEES institution shall become permanently the property of the UEES institution.

UEES countries must ensure that no level of government taxes any UEES Institution or any organization the UEES institution establishes to assist in carrying out its mandate. This would hamper the good the UEES can do. The UEES is like a not-for-profit organization.

UEES countries must implement tax reforms to integrate the UEES system with their national system of taxation and other systems as necessary.

A UEES country must alter their legal or administrative system to accommodate the UEES system and its rules and regulations.

A UEES country has an obligation to actively seek out and prosecute persons or organizations that seek to circumvent or transgress the UEES related laws particularly those pertaining to entities that do not remit licensing fees due to the UEES.

A UEES country has an obligation to stop completely countries that are not UEES countries from selling UEES inventions in UEES countries.

If one person, company or organization in a non-UEES country knowingly uses a UEES idea, that country loses its status as a country a UEES country can buy goods or services from. After the infraction has been corrected and a time penalty has elapsed the non-UEES country can resume trading with the UEES country.

Re-establishment of trading relations between UEES nations and a non-UEES nation after an infraction of the rule against using UEES inventions being used by entities in non-UEES nations will only be permissible after a minimum period of one year after the cessation of using the UEES invention(s).

National governments that adopt the ‘UEES system’ should legislate that they will not purchase goods or services from countries that utilize UEES registered inventions without participating fully in the UEES system.

If a country does not utilize UEES registered ideas and does not participate in the UEES system it may enjoy normal trading relations with UEES countries.

A UEES country should legislate that assets of countries that use UEES inventions without fully participating in the UEES can be seized to pay damages such as for unpaid licensing fees and the like.

A UEES country must permit the UEES bank to operate in its country.

A UEES country has an obligation to establish books of account in which UEES transactions are recorded. (UEES payments and receipts on account, taxes owed and paid, and the like.)

A UEES country must establish a department that will have the mandate to liaise with the UEES institution and other UEES countries.

UEES countries may implement a UEES salary/wage loan which is generally paid to all UEES employees or UEES students.

Funds must be loaned by UEES national governments to their citizens who become UEES employees.

Countries should legislate that UEES salary loans must be repaid before income from any source can be kept.

If desired, national governments in consultation with the Council of 24, the senior management of the UEES, may establish a net worth base amount in a UEES country. A UEES employee with a net worth higher than the base amount need not be paid the full UEES salary by their national governments. Unrealized UEES salary credits due a UEES employee are not included in this calculation of net worth.

### The Uees Institution

Much of what the UEES institution does has been described above. In the ‘prophetic example’ submitted with the provisional application there are many ‘recommendations’ as to how the UEES institution should be established and operated. Some of the most important recommendations are:

That a council of 24 persons should be the senior management of the UEES.

People should be elected to the council of 24 by the next lower level of management.

The election of UEES personnel should be based on merit and suitability for the job.

No quota should be established for a number of employees or for positions of employees that must be allocated to each country. If one or several countries citizens dominate the UEES in any way then that condition must not be allowed to continue.

There should be no nepotism or cronyism in the UEES institution.

No person should be allowed to work for the UEES institution or any of its affiliates for more than 10 years.

All employees of the UEES institution should receive the same salary based on what the average engineer would earn in the employee's country of residence.

Each country that is a UEES user should establish offices and residences for the council members and their immediate family.

The council of 24 should establish themselves in the offices and residences of a different UEES user country every year. The rotation schedule should be fixed; however, if there are dangerous problems in the country where the UEES is to establish itself for a year then that rotation may be switched.

The operations of the UEES institution should be distributed among all UEES countries.

Please refer to the ‘prophetic example’ that accompanied the provisional application for more details.

### BRIEF SUMMARY OF THE INVENTION

The UEES offers Inventors the opportunity to turn over their inventions to a government sanctioned organization in return for a generous compensation package based on the economic viability of the Inventor's invention as proven by using a measure like ‘net sales’ on which to calculate the inventor's monetary remuneration. The term of time for which inventors could receive compensation has lengthened to 25 years or life, whichever is longest, so the inventor will no longer loose his right to earn compensation just when his invention starts to earn revenue. The government will legislate and ensure through their tax auditors that companies or the like that use the inspired Inventor's business invention remit a licensing fee to the UEES institution. The UEES institution then compensates the Inventor.

There is no fee charged to Inventors for having their new business idea evaluated by the ‘Idea Bank’ and little, if anything, to lose by trying to register an idea invention.

An Inventor could submit his invention to both a patent office and the UEES. If the Inventor receives a patent and wishes to transfer the patent to the UEES for the UEES compensation package this is allowable for 3 years after the date the patent is granted.

UEES institution will have a marketing division. Registered new UEES business ideas are circulated and made available in a variety of media. Some of the media may include the internet, newspapers, magazines, television, radio and the like to people, companies, government institutions and the like in countries that use the UEES system.

Not all new business ideas submitted will be useable or immediately desired in the global market. The market, that is the people, companies, governments and the like in UEES countries, will assess the viability of the new business ideas for the local or global market to determine which ones could and should be manufactured, if a product, or service offered if a new business idea for a service. They will utilize the ideas that they believe will be most marketable, that is people will either want to have or need to have the invention, in local markets and/or the world market. The wiser their choice is about which UEES company to join the more likely they are to earn their full salary and to participate in any profits if the UEES company is sold.

The definition of what constitutes intellectual property is new in that an invention is now any idea that can be converted into a new business. This would include new service businesses and other new types of businesses that have not yet been considered.

Governments can generally use the UEES two ways, The first way is to allow any party, person, company, organization or the like in a UEES country to use the invention as an invention around which a business could be started. The second way governments could use the UEES to dramatically reduce unemployment is to reserve use of all or most UEES inventions for the use of UEES workers who would be paid a UEES salary/wage loan.

Users of UEES inventions will continue to pay the full licensing fee for the use of the UEES invention until they no longer use the invention.

The outcomes of the UEES implementation are expected to be

The optimization of use of the workforce in UEES using countries

The raising of large sums of funds that should be used to ameliorate the effects of industry on the environment and other worthwhile causes

The partial funding through the UEES student option of the higher education of persons desiring it in UEES using countries.

It is a principal goal of a UEES company to become so successful that it can change its status to become a regular private sector company. After this transition the company will continue to pay the licensing fee to the UEES until it stops using the UEES invention.

It is apparent that globally the people using the economic tools and governmental systems around the world are failing to provide effective, positive solutions for some of the most critical problems human beings and other species now face. The first problem is the environment. If the world's environment is ‘destroyed’ it will not be necessary to worry about other problems. A second large problem is the human problem of employment in a changing world. How can all types of people with diverse abilities and economic means prepare for their economic life in the future? How will they obtain funds on which to live and hopefully to thrive in the future. The UEES, particularly as it has been written up in the ‘prophetic example’ which was submitted with the ‘provisional’ patent application, provides a new, international, pragmatic system or method that is easy to understand if not to implement, that can, should and must be used soon to address the issues raised above and elsewhere in this patent application. Many parents would protect their children with their lives, but will they, for the sake of their and their children's future, involve themselves in the search for and the struggle to implement a new and more effective way of capturing and using the business ideas that will provide work, societal advancement and a habitable environment themselves and for those same children? Only God knows.

TABLE 1
Annual Payment Made to Inventor based on Net Sales

| A | | |
|---|---|---|
| Reported cumulative | B | |
| annual net sales of | Percent of | |
| companies on which | reported net | C |
| inventor's | sales that | Annual amount |
| compensation is | inventor is | that is paid to the |
| based. | paid. | inventor. (A*B) |
| $100,000.00 | 2% | $2,000.00 |
| $1,000,000.00 | 2% | $20,000.00 |
| $10,000,000.00 | 2% | $200,000.00 |
| $100,000,000.00 | 2% | $2,000,000.00 |
| $500,000,000.00 | 2% | $10,000,000.00 |
| $1,000,000,000.00 | 2% | $20,000,000.00 |
| $10,000,000,000.00 | 2% | $200,000,000.00 |

TABLE 2
GENERAL COMPARISON OF PATENT SYSTEMS AMD THE UEES
As the UEES deals with the capture, conferring of ownership and use of intellectual property it should
be compared to patents and the patenting process. This is done briefly below. Some very significant
differences can be seen. This comparison does not show all differences between the two systems.

| QUESTION | PATENT SYSTEM | UEES |
|---|---|---|
| QUESTION - In what language are | Patent System - Normally the language of the | UEES - In any national language. |
| applications or submissions made? | country in which the patent application is made. | |
| QUESTION - What can be ‘patented’ | Patent System - An invention or discovery of any | UEES - Any ‘new business idea’ or ‘newidea for |
| or ‘registered’? | new and useful process, machine, manufacture, | abuless’ that can be used immediately or in a short |
| | or composition of matter, or any new and useful | period of time around which a business can be |
| | improvement thereof. | established. Generally this idea will be for new |
| | | products and designs to manufacture and new services |
| | | to render. |
| QUESTION - Who or what approves a | Patent System - Each country's patent office | UEES - The UEES's Idea Bank approves a business |
| patent or a registered idea? | issues a patent for their country after the | idea as a new registered business idea after its review |
| | application has been approved by the country's | by UEES examiners. This registration applies to all |
| | patent offices patent examiner. | UEES countries. |
| QUESTION - Ownership of idea | Patent System - The government confers a limited | UEES - The governments of countries that use the UEES |
| | right of ownership of the inventor's idea by giving | confer ownership of the inventor's idea on the idea bank. |
| | the inventor a patent on the invention idea. | The idea bank owns the business idea forever. |
| QUESTION - For how long does the | Patent System - The life or duration of most patents | UEES - The inventor receives compensation based on the |
| inventor receive compensation for the | is approximately 20 years. Compensation depends | economic success of his invention. A percentage of the |
| invention or business idea. | on contract negotiated by the patent owner or | net sales of user Business companies is the suggested |
| | holder. | measure. It would be paid for 25 years or life, whichever |
| | | is longest. |
| QUESTION - Who markets/distributes | Patent System - The holder of the patent or his | UEES - The UEES institution distributes the idea using |
| the patented or registered business | appointees. | mass media communication tools such as the internet. |
| idea? | | |
| QUESTION - Who pays the patent | Patent System - The persons or companies that | UEES - The UEES institution's bank or financial |
| holder for the use of the patent or | contract to use the patent. | division. |
| the inventor or use of a registered | | |
| idea. | | |
| QUESTION - How is the patent owner | Patent System - The patent owner or his appointees | UEES - All inventors of a registered UEES idea receive |
| or registered UEES idea compensated? | negotiate contracts with parties that wish to use | payment from the UEES's Lord's Bank on a set basis. |
| | his patent. | It has been suggested that inventors should receive 2% of |
| | | the net sales associated with the invention. |
| QUESTION -How does a person apply | Patent System - Inventor files a patent application | UEES companies related to the use of the registered |
| for a patent or to register a | in prescribed format in each country in which the | UEES idea for life or 21 years, which is longest. |
| business idea? | inventor wants a patent. Patent attorneys are | |
| | recommended to assist in these applications. | |
| QUESTION - How does a person apply | Patent System - The inventor files an application in | UEES - The inventor transmits his idea to the UEES's |
| for a patent or to register a | prescribed format in each country in which the | Idea Bank in any reasonable format where it is reviewed, |
| business idea? | patent holder wants a patent. Patent attorneys | put into good and legal form by UEES examiners and |
| | are recommended to assist in these applications | registered if the inventor's idea is a new business |
| | as procedures can be complicated and legal | idea. |
| | protections must be inscribed in the application. | |
| QUESTION - If a patent is granted | Patent System - In the country in which the patent | UEES - If the idea is registered then the idea is registered |
| or a business idea is registered, | is granted. | in all UEES countries. |
| in what countries does the patent | | |
| or registration apply? | | |
| QUESTION - Are application fees | Patent System - Generally fees must be paid with | UEES - No fees are charged to inventors except for |
| paid to obtain patents or to | the application to each country for which a patent | banking fees like currency conversion charges. |
| register ideas in the UEES? | has been applied. International patent applications | |
| | generally require the services of an international | |
| | patent attorney. | |
| QUESTION - ‘Protection’ of a | Patent System - Patent owner must use courts to sue | UEES - Users of UEES inventions have a legal |
| Patented invention or Registered | infringers of his patent. Patent owner must be | obligation to pay licensing fees in UEES countries. |
| idea. | prepared to pay legal costs to sue. | UEES or Government auditors and lawyers verify the |
| | | amounts that should be paid to the UEES bank by |
| | | UEES invention users. There is no cost to as the |
| | | inventor does not own the invention. The UEES |
| | | institution and the governments of UEES using |
| | | countries will ensure that UEES inventions are |
| | | well protected from any encroachment. |
| QUESTION - What other benefits | This is the better way of maintaining control of | UEES - Overtime the UEES can provide significant |
| might the Patent system or the | the ownership of an invention. | funding for environmental, health, spiritual and |
| UEES provide? | | other internationally important projects. UEES |
| | | student financing described in the body of the |
| | | document could be undertaken. |

TABLE 3
Macro Example 1 - Total Amount paid by national Government

| | | A × B |
|---|---|---|
| A | B | Total Amount paid |
| Number of | National | by the National |
| people receiving | Government | Government to |
| government | UEES wage | support UEES |
| UEES loans | amount | wage/salary loans |
| 20,000,000 | $20,000 | $400,000,000,000 |

TABLE 4
Macro Example 1 - Illustration of Loan Repayment & Cost of Program

| | | | | E | | | H |
|---|---|---|---|---|---|---|---|
| | | | | 20 mil- | | | (D − E) |
| | | | D | lion × D × .5 | | | Cost of Loan Program |
| A | | | [A − (A × B)] | Number of people | F | | before considering |
| Gross Amount | | | Cost of Loan | of peopla paying | Assumed | G | other UEES Program |
| Loaned to 20 | | | Program before | income tax | income | E × F | Benefits less |
| million people | | C | considering | assuming 50% of | tax | Total | assumed income |
| at $20,000 | B | (A × B) | other UEES | people paying | received | assumed | tax receipts. |
| each from | Repay- | Amount of | Program | back loan will | as per | income tax | Minus sign denotes |
| Chart 2 | ment % | Repayment | Benefits. | pay tax. | person | received. | program profit |
| $400,000,000,000 | 50% | $200,000,000,000 | $200,000,000,000 | 5,000,000.00 | $5,000 | $25,000,000,000 | $175,000,000,000 |
| $400,000,000,000 | 60% | $240,000,000,000 | $160,000,000,000 | 6,000,000.00 | $5,000 | $30,000,000,000 | $130,000,000,000 |
| $400,000,000,000 | 70% | $280,000,000,000 | $120,000,000,000 | 7,000,000.00 | $5,000 | $35,000,000,000 | $85,000,000,000 |
| $400,000,000,000 | 80% | $320,000,000,000 | $80,000,000,000 | 8,000,000.00 | $5,000 | $40,000,000,000 | $40,000,000,000 |
| $400,000,000,000 | 90% | $360,000,000,000 | $40,000,000,000 | 9,000,000.00 | $5,000 | $45,000,000,000 | −$5,000,000,000 |
| $400,000,000,000 | 100% | $400,000,000,000 | $0 | 10,000,000.00 | $5,000 | $50,000,000,000 | −$50,000,000,000 |

TABLE 5
Macro Example 2- Total Amount paid by national Government

| | | A × B |
|---|---|---|
| A | B | Total Amount paid |
| Number of | National | by the National |
| people receiving | Government | Government to |
| government | UEES wage | support UEES |
| UEES loans | amount | wage/salary loans |
| 40,000,000 | $30,000 | $1,200,000,000,000 |

TABLE 6
Macro Example 2 - Illustration of Loan Repayment & Cost of Program

| | | | | E | | | H |
|---|---|---|---|---|---|---|---|
| | | | | 30 mil- | | | (D − E) |
| | | | D | lion × B | | | Cost of Loan Program |
| | | | (A − C) | Number of people | F | | before considering |
| A | | | Cost of Loan | of peopla paying | Assumed | | other UEES Program |
| Gross Amount | | | Program before | income tax | income | G | Benefits less |
| Loaned to 40 | | C | considering | assuming 50% of | tax | Total | assumed income |
| million people | B | (A × B) | other UEES | people paying | received | assumed | tax receipts. |
| at $30,000 | Repay- | Amount of | Program | back loan will | is $5,000 | income tax | Minus sign denotes |
| each | ment % | Repayment | Benefits. | pay tax. | per person | received. | program profit |
| $1,200,000,000,000 | 40% | $480,000,000,000 | $720,000,000,000 | 6,000,000 | $5,000 | $30,000,000,000 | $690,000,000,000 |
| $1,200,000,000,000 | 50% | $600,000,000,000 | $600,000,000,000 | 7,500,000 | $5,000 | $37,500,000,000 | $562,500,000,000 |
| $1,200,000,000,000 | 60% | $720,000,000,000 | $480,000,000,000 | 9,000,000 | $5,000 | $45,000,000,000 | $435,000,000,000 |
| $1,200,000,000,000 | 70% | $840,000,000,000 | $360,000,000,000 | 10,500,000 | $5,000 | $52,500,000,000 | $307,500,000,000 |
| $1,200,000,000,000 | 80% | $960,000,000,000 | $240,000,000,000 | 12,000,000 | $5,000 | $60,000,000,000 | $180,000,000,000 |
| $1,200,000,000,000 | 90% | $1,080,000,000,000 | $120,000,000,000 | 13,500,000 | $5,000 | $67,500,000,000 | $52,500,000,000 |
| $1,200,000,000,000 | 100% | $1,200,000,000,000 | $0 | 15,000,000 | $5,000 | $75,000,000,000 | −$75,000,000,000 |

TABLE 7
Cost to provide UEES salary/wage to different numbers of recipients and different annual amounts

| | Total cost to UEES | Total cost to UEES | Total cost to UEES | Total cost to UEES |
|---|---|---|---|---|
| Number of persons | country if each person | country if each person | country if each person | country if each person |
| receiving UEES | received per year | received per year | received per year | received per year |
| wage/salary | $5,000 | $10,000 | $20,000 | $30,000 |
| 1,000,000 | 5,000,000,000 | $10,000,000,000 | $20,000,000,000 | $30,000,000,000 |
| 2,000,000 | $10,000,000,000 | $20,000,000,000 | $40,000,000,000 | $60,000,000,000 |
| 3,000,000 | $15,000,000,000 | $30,000,000,000 | $60,000,000,000 | $90,000,000,000 |
| 4,000,000 | $20,000,000,000 | $40,000,000,000 | $80,000,000,000 | $120,000,000,000 |
| 5,000,000 | $25,000,000,000 | $50,000,000,000 | $100,000,000,000 | $150,000,000,000 |
| 6,000,000 | $30,000,000,000 | $60,000,000,000 | $120,000,000,000 | $180,000,000,000 |
| 7,000,000 | $35,000,000,000 | $70,000,000,000 | $140,000,000,000 | $210,000,000,000 |
| 8,000,000 | $40,000,000,000 | $80,000,000,000 | $160,000,000,000 | $240,000,000,000 |
| 9,000,000 | $45,000,000,000 | $90,000,000,000 | $180,000,000,000 | $270,000,000,000 |
| 10,000,000 | $50,000,000,000 | $100,000,000,000 | $200,000,000,000 | $300,000,000,000 |
| 11,000,000 | $55,000,000,000 | $110,000,000,000 | $220,000,000,000 | $330,000,000,000 |
| 12,000,000 | $60,000,000,000 | $120,000,000,000 | $240,000,000,000 | $360,000,000,000 |
| 13,000,000 | $65,000,000,000 | $130,000,000,000 | $260,000,000,000 | $390,000,000,000 |
| 14,000,000 | $70,000,000,000 | $140,000,000,000 | $280,000,000,000 | $420,000,000,000 |
| 15,000,000 | $75,000,000,000 | $150,000,000,000 | $300,000,000,000 | $450,000,000,000 |
| 16,000,000 | $80,000,000,000 | $160,000,000,000 | $320,000,000,000 | $480,000,000,000 |
| 17,000,000 | $85,000,000,000 | $170,000,000,000 | $340,000,000,000 | $510,000,000,000 |
| 18,000,000 | $90,000,000,000 | $180,000,000,000 | $360,000,000,000 | $540,000,000,000 |
| 19,000,000 | $95,000,000,000 | $190,000,000,000 | $380,000,000,000 | $570,000,000,000 |
| 20,000,000 | $100,000,000,000 | $200,000,000,000 | $400,000,000,000 | $600,000,000,000 |
| 21,000,000 | $105,000,000,000 | $210,000,000,000 | $420,000,000,000 | $630,000,000,000 |
| 22,000,000 | $110,000,000,000 | $220,000,000,000 | $440,000,000,000 | $660,000,000,000 |
| 23,000,000 | $115,000,000,000 | $230,000,000,000 | $460,000,000,000 | $690,000,000,000 |
| 24,000,000 | $120,000,000,000 | $240,000,000,000 | $480,000,000,000 | $720,000,000,000 |
| 25,000,000 | $125,000,000,000 | $250,000,000,000 | $500,000,000,000 | $750,000,000,000 |
| 26,000,000 | $130,000,000,000 | $260,000,000,000 | $520,000,000,000 | $780,000,000,000 |
| 27,000,000 | $135,000,000,000 | $270,000,000,000 | $540,000,000,000 | $810,000,000,000 |
| 28,000,000 | $140,000,000,000 | $280,000,000,000 | $560,000,000,000 | $840,000,000,000 |
| 29,000,000 | $145,000,000,000 | $290,000,000,000 | $580,000,000,000 | $870,000,000,000 |
| 30,000,000 | $150,000,000,000 | $300,000,000,000 | $600,000,000,000 | $900,000,000,000 |
| 31,000,000 | $155,000,000,000 | $310,000,000,000 | $620,000,000,000 | $930,000,000,000 |
| 32,000,000 | $160,000,000,000 | $320,000,000,000 | $640,000,000,000 | $960,000,000,000 |
| 33,000,000 | $165,000,000,000 | $330,000,000,000 | $660,000,000,000 | $990,000,000,000 |
| 34,000,000 | $170,000,000,000 | $340,000,000,000 | $680,000,000,000 | $1,020,000,000,000 |
| 35,000,000 | $175,000,000,000 | $350,000,000,000 | $700,000,000,000 | $1,050,000,000,000 |
| 36,000,000 | $180,000,000,000 | $360,000,000,000 | $720,000,000,000 | $1,080,000,000,000 |
| 37,000,000 | $185,000,000,000 | $370,000,000,000 | $740,000,000,000 | $1,110,000,000,000 |
| 38,000,000 | $190,000,000,000 | $380,000,000,000 | $760,000,000,000 | $1,140,000,000,000 |
| 39,000,000 | $195,000,000,000 | $390,000,000,000 | $780,000,000,000 | $1,170,000,000,000 |
| 40,000,000 | $200,000,000,000 | $400,000,000,000 | $800,000,000,000 | $1,200,000,000,000 |

TABLE 8
Illustration of Government Loan and its Repayment

| | | | C | | | |
|---|---|---|---|---|---|---|
| | | B | B/total B | | | |
| | | Negociated | Salary as % of | D | E | |
| | A | Salary/wage | Total | C × $180,000 | Repayment | F |
| | Government | with UEES | negciated | Distribution | Government | D − E |
| Staff | Loan for year | company | salary/wage | Year 1 | Loan | Remainder |
| Staff 1 | $20,000 | $40,000 | 14.29% | $25,714.29 | $20,000 | $5,714.29 |
| Staff 2 | $20,000 | $50,000 | 17.86% | $32,142.86 | $20,000 | $12,142.86 |
| Staff 3 | $20,000 | $55,000 | 19.64% | $35,357.14 | $20,000 | $15,357.14 |
| Staff 4 | $20,000 | $65,000 | 23.21% | $41,785.71 | $20,000 | $21,785.71 |
| Staff 5 | $20,000 | $70,000 | 25.00% | $45,000.00 | $20,000 | $25,000.00 |
| | $100,000 | $280,000 | 100.00% | $180,000.00 | $100,000 | $80,000.00 |

1. A national government or international governments establish and support an institution that offers a standard contract to all Inventors for new business idea inventions. See Diagram 1.
The contract's terms state that if the Inventor sends a new idea for a business or a new business idea to the UEES institution and it is found to be new and could be fabricated or implemented with current technology then the Inventor will receive a standard compensation package for the invention with compensation based on the economic viability of the invention, generally the net sales of the invention.
The contract also states the UEES institution will receive the ownership right of the invention from the government. The Inventor will not have an ownership right nor will the government. As the invention is now the property of the UEES institution, the institution markets the invention to people, companies and organizations in UEES countries. When these entities operate a business using a registered UEES business idea a national legislated licensing fee must be paid to the UEES institution. From this licensing fee are paid the monetary compensation the Inventor is entitled to and the operating costs of the UEES institution. Excess funds can be used to finance projects to keep the world habitable, prevent famine, promote good health and other worthwhile undertakings.

2. See Table 8—Illustration of Government Loan and its Repayment. The second claim of originality is the UEES salary/wage loan program. Loans may be made from the government to persons working on UEES inventions. If countries use this option UEES inventions are generally reserved for the use of persons receiving a UEES salary/wage loan from the government. Any salary/wage loan balance that the person working on the UEES project is in receipt of must be paid to the government first as well as any taxes due before salary/wage distributions can be kept as disposable income. If salary/wage distributions are made to UEES workers and the loans outstanding have been paid to the government, that portion of the money not due for tax to the government may be kept by the UEES worker. UEES salary/wage payments may also be made in the UEES student program. This program partially or fully finances adult students wishing to continue their post-secondary education. It does this by having the government pay the student a UEES salary/wage loan. Any money the student earns must go towards repaying his loan first. An advantage of this method is that the student has a constant supply of funding and does not have to rely on erratic part-time work or other funding to live. A condition of the loan could be that the student would be obligated to take employment in UEES work if he was unable to obtain private sector or public sector employment shortly after his student days ended.

3. The third claim is the unique ability of the UEES to raise funds over and above the funds required to reimburse the compensation due to the Inventor and to pay the operating costs of the UEES institution. This is accomplished by adding a percentage on to the licensing fee that would result in excess funds being received from invention licensees. At this time of economic hardship around the world it is very difficult to find the funds necessary to deal with environmental problems like global warming and other areas. By providing funding to parties involved in seeking and implementing corrective actions, a very successful implemented UEES provides a way to help to reduce problems caused by industrialization and other important areas requiring attention i.e. food supply and health issues.
